(19) United States
(12) Patent Application Publication
(10) Pub. No.: US 2017/0028521 A1
(43) Pub. Date: Feb. 2, 2017

(54) MACHINE LEARNING DEVICE, SCREW FASTENING SYSTEM, AND CONTROL DEVICE THEREOF

(71) Applicant: FANUC CORPORATION, Yamanashi (JP)

(72) Inventor: Kazuhiro YAMAMOTO, Yamanashi (JP)

(21) Appl. No.: 15/223,166

(22) Filed: Jul. 29, 2016

(30) Foreign Application Priority Data
Jul. 31, 2015 (JP) 2015-151953

(51) Int. Cl. B23P 19/06; G05B 19/418

(52) U.S. Cl. CPC B23P 19/066; G05B 19/41805; G05B 2219/33034; G05B 2219/45203

(57) ABSTRACT

A machine learning device for learning the fastening operation of a screw by a screwdriver includes a state observation unit for observing state variables consisting of at least one of a rotational speed of the screwdriver, a rotational direction of the screwdriver, a position of the screwdriver and an inclination of the screwdriver and at least one of a fastening quality of the screw fastened by the screwdriver and a fastening time for which the screw is fastened by the screwdriver, and a learning unit for learning at least one of the rotational speed, the rotational direction, the position and the inclination, observed by the state observation unit and at least one of a change of the fastening quality and a change of the fastening time, observed by the state observation unit in association with each other.

### BACKGROUND OF THE INVENTION

1. Field of the Invention

The present invention relates to a machine learning device, a screw fastening system including such a machine learning device, and a control device thereof.

2. Description of the Related Art

An automatic screw fastening operation in which a screw is fastened using a screwdriver has been practiced. In such an automatic screw fastening operation, a screw is fastened at a constant high speed, and accordingly, a screw jam sometimes occurs.

In Japanese Unexamined Patent Publication (Kokai) No. 2011-073105, the height of a screw which has been screwed into a workpiece is detected and if the screw height is out of a predetermined range, the screw fastening is judged to be inappropriate.

### SUMMARY OF THE INVENTION

In the case of inappropriate fastening, the automated assembly line is stopped, and an alarm is output to notify the operator. Thus, the operator adjusts the screw-fastened portion by hand and thereafter, resumes the automated assembly line.

However, if the automated assembly line is stopped each time a screw jam occurs, productivity is significantly reduced.

The present invention has been completed in view of these circumstances and is aimed to provide a machine learning device which can prevent the productivity from decreasing, a screw fastening system including such a machine learning device, and a control device thereof.

In order to achieve the aforementioned object, according to the first aspect of the invention, there is provided a machine learning device for learning the fastening operation of a screw by a screwdriver, comprising a state observation unit for observing state variables including at least one of a rotational speed of the screwdriver, a rotational direction of the screwdriver, a position of the screwdriver and an inclination of the screwdriver, and at least one of a fastening quality of the screw fastened by the screwdriver and a fastening time for which the screw is fastened by the screwdriver, and

a learning unit for learning at least one of the rotational speed, the rotational direction, the position and the inclination, observed by the state observation unit and at least one of a change of the fastening quality and a change of the fastening time, observed by the state observation unit in association with each other.

According to the second aspect of the invention, in a machine learning device according to the first aspect, the learning unit comprises a reward calculation unit which calculates a reward based on at least one of the fastening quality and the fastening time, observed by the state observation unit, and a function update unit which updates a function to determine at least one of an optimum rotational speed of the screwdriver, an optimum rotational direction of the screwdriver, an optimum position of the screwdriver and an optimum inclination of the screwdriver, from the current state variables based on the reward calculated by the reward calculation unit.

According to the third aspect of the invention, in a machine learning device according to the second aspect, the reward calculation unit is configured to decrease the reward when the fastening time is greater than a predetermined time.

According to the fourth aspect of the invention, in a machine learning device according to the second or third aspect, the reward calculation unit is configured to increase the reward when the fastening time is not greater than a predetermined time.

According to the fifth aspect of the invention, in a machine learning device according to any one of the second to fourth aspects, the fastening quality includes at least one of a screw fastening torque and a position of a screw which has been fastened, and the reward calculation unit is configured to reduce the reward in at least one of the cases where the screw fastening torque is out of a predetermined range and where the screw position is greater than a predetermined value.

According to the sixth aspect of the invention, in a machine learning device according to any one of the second to fifth aspects, the fastening quality includes at least one of a screw fastening torque and a position of a screw which has been fastened, and the reward calculation unit is configured to increase the reward in at least one of the cases where the screw fastening torque is within a predetermined range and where the screw position is not greater than a predetermined value.

According to the seventh aspect of the invention, a control device for a screw fastening system in which a screw is fastened by a screwdriver comprises a rotational speed regulation unit which regulates the rotational speed of the screwdriver, a rotational direction regulation unit which regulates the rotational direction of the screwdriver, a position regulation unit which regulates the position and inclination of the screwdriver, a fastening quality detection unit which detects the fastening quality of the screw fastened by the screwdriver, a fastening time detection unit which detects the fastening time required to fasten the screw by the screwdriver, a machine learning device according to any one of the first to sixth aspects, and a decision making unit which determines and outputs an amount of adjustment of at least one of the rotational speed regulation unit, the rotational direction regulation unit, the position regulation unit, from the current state variables based on the learning result of the learning unit so as to determine at least one of the optimum rotational speed of the screwdriver, the optimum rotational direction of the screwdriver, the optimum position of the screwdriver, and the optimum inclination of the screwdriver.

According to the eighth aspect of the invention, there is provided a screw fastening system comprising a control device according to the seventh aspect and a screw fastening device having the screwdriver.

The aforementioned object, features and merits and other objects, features and merits of the present invention will become more apparent from the detailed description of the representative embodiments of the present invention illustrated in the accompanying drawings.

### BRIEF DESCRIPTION OF THE DRAWINGS

FIG. 1 is a function block diagram of a screw fastening system according to the present invention.

FIG. 2 is an enlarged block diagram of a machine learning part.

FIG. 3 is a flow chart showing the operations of the machine learning part.

### DETAILED DESCRIPTION

The embodiments of the invention will be discussed below with reference to the accompanying drawings. In the drawings, the same or corresponding components are assigned the same reference numerals. For the sake of clarity, the scale of the drawings has been appropriately changed.

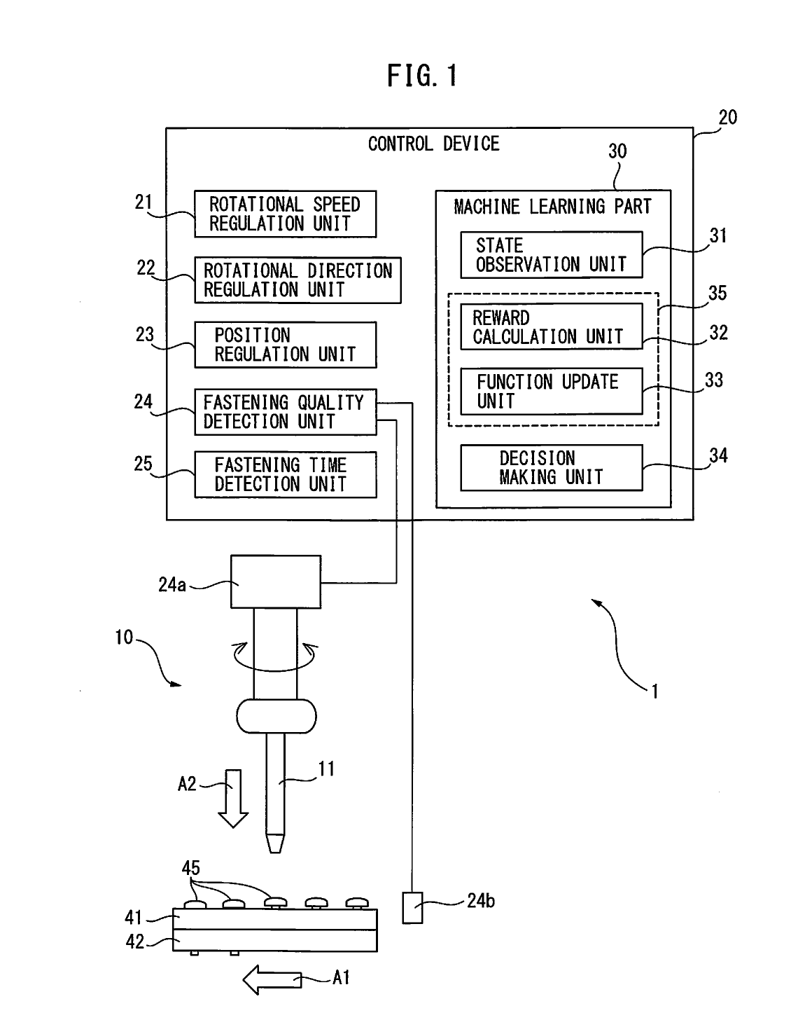

FIG. 1 is a function block diagram of a screw fastening system according to the present invention. As can be seen in FIG. 1, the screw fastening system 1 essentially includes a screw fastening device 10 having a screwdriver 11 and a control device 20 which controls the screw fastening device 10.

In the lower part of FIG. 1, two planar plates 41 and 42 which are superimposed one on another are illustrated. The planar plates 41 and 42 are provided with a plurality of threaded through holes (not shown) and screws 45 are inserted in the through holes of the planar plate 41. The planar plates 41 and 42 are transferred in the direction indicated by the arrow A1 in FIG. 1 stepwise by a predetermined distance. When a certain screw 45 reaches a position corresponding to the screwdriver 11 of the screw fastening device 10, the screwdriver 11 is moved downward in the direction indicated by the arrow A2 and is rotated in a certain direction to fasten and engage the screw 45 with the planar plates 41 and 42.

The control device 20 is a digital computer and is composed of a rotational speed regulation unit 21 which regulates the rotational speed of the screwdriver 11, a rotational direction regulation unit 22 which regulates the rotational direction of the screwdriver 11, and a position regulation unit 23 which regulates the position and inclination of the screwdriver 11. The respective amounts of adjustment of the rotational speed regulation unit 21, the rotational direction regulation unit 22 and the position regulation unit 23 are determined by the machine learning part 30 which will be discussed hereinafter. Note that, in the following discussion, the position and inclination of the screwdriver 11 may be referred to merely as the position of the screwdriver 11″.

Furthermore, the control device 20 includes a fastening quality detection unit 24 which detects the fastening quality of the screw 45 fastened by the screwdriver 11. The fastening quality detected by the fastening quality detection unit 24 includes a screw fastening torque detected by a torque sensor 24a and a position of the fastened screw 45 detected by a distance sensor 24b. As may be understood from FIG. 1, the screw position detected by the distance sensor 24b represents the distance between the lower end of the head of the screw 45 and the planar plate 41.

Moreover, the control device 20 includes a fastening time detection unit 25 which detects the time required to fasten the screw 45 by the screwdriver 11. The fastening time detection unit 25 detects the time from the commencement of the rotation of the screw 45 by the screwdriver 11 to the completion of the fastening operation as a fastening time.

As can be seen in FIG. 1, the control device 20 further includes the machine learning part 30. The machine learning part 30 may be attached to the control device 20 as an external machine learning device.

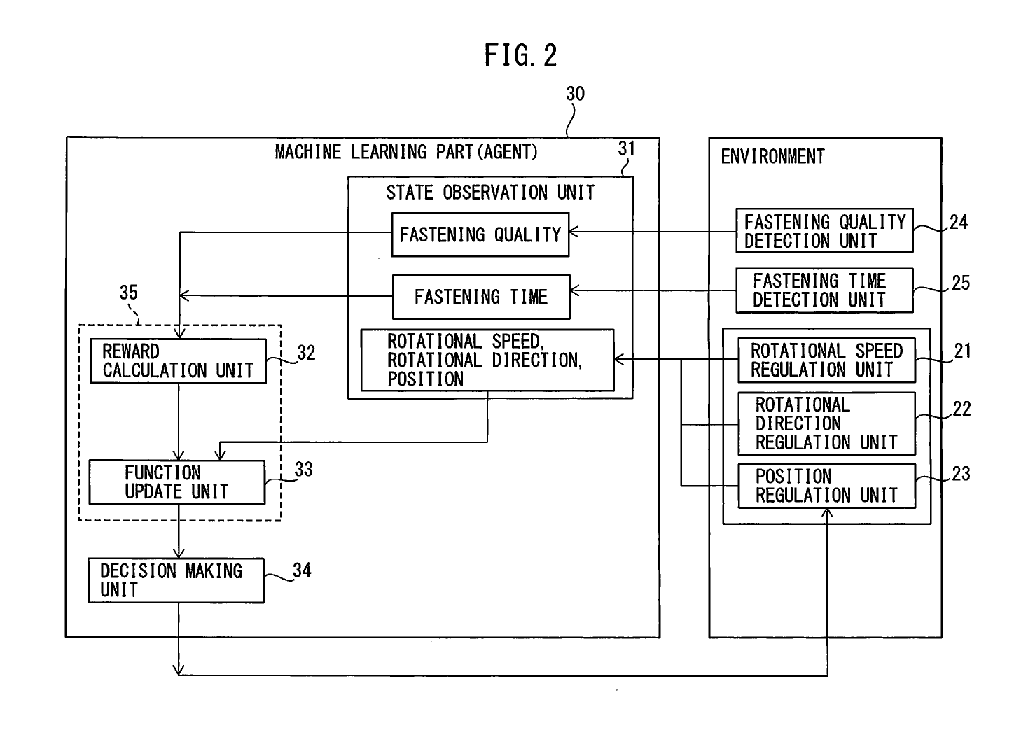

With reference to FIG. 2 which is an enlarged view of the machine learning part, the machine learning part 30 includes a state observation unit 31 which observes state variables consisting of at least one of the rotational speed of the screwdriver 11 for fastening the screw, the rotational direction of the screwdriver 11, the position of the screwdriver 11, and the inclination of the screwdriver 11 and at least one of the fastening quality of the screw fastened by the screwdriver 11 and the fastening time for which the screw is fastened by the screwdriver 11. The state observation unit 31 can successively store the state variables together with the observation time.

Furthermore, the machine learning part 30 includes a learning unit 35 which learns at least one of the rotational speed, the rotational direction, the position, and the inclination, all detected by the state observation unit 31 and at least one of a change of the fastening quality and a change of the fastening time detected by the state observation unit 31 in association with each other.

The learning unit 35 can carry out various types of machine learning, such as supervised learning, unsupervised learning, semi-supervised learning, reinforcement learning, transduction, and multi-task learning. In the following discussion, it is assumed that the learning unit 35 performs reinforcement learning by Q-learning.

With reference to FIG. 2, the machine learning part 30 corresponds to an agent in the reinforcement learning. The rotational speed regulation unit 21, the rotational direction regulation unit 22, the position regulation unit 23, the fastening quality detection unit 24, and the fastening time detection unit 25 detect an environmental state.

The learning unit 35 which performs reinforcement learning includes a reward calculation unit 32 which calculates a reward based on at least one of the fastening quality and the fastening time, detected by the state observation unit 31, and a function update unit 33 (Artificial Intelligence) which updates a function to determine at least one of the optimum rotational speed of the screwdriver 11, the optimum rotational direction of the screwdriver 11, the optimum position of the screwdriver 11, and the optimum inclination of the screwdriver 11, e.g., an action value function (action value table), from current state variables, based on the reward calculated by the reward calculation unit 32. As a matter of course, the function update unit 33 may update other functions.

Furthermore, the machine learning part 30 includes a decision making unit 34 which detects and outputs an amount of adjustment of at least one of the rotational speed regulation unit 21, the rotational direction regulation unit 22, and the position regulation unit 23 from the current variables, based on the learning result of the learning unit 35 so as to determine at least one of the optimum rotational speed of the screwdriver 11, the optimum rotational direction of the screwdriver 11, the optimum position of the screwdriver 11, and the optimum inclination of the screwdriver 11. The decision making unit 34 learns the selection (decision) of a more favorable action. Note that the control device 20 in place of the machine learning part 30 may include the decision making unit 34.

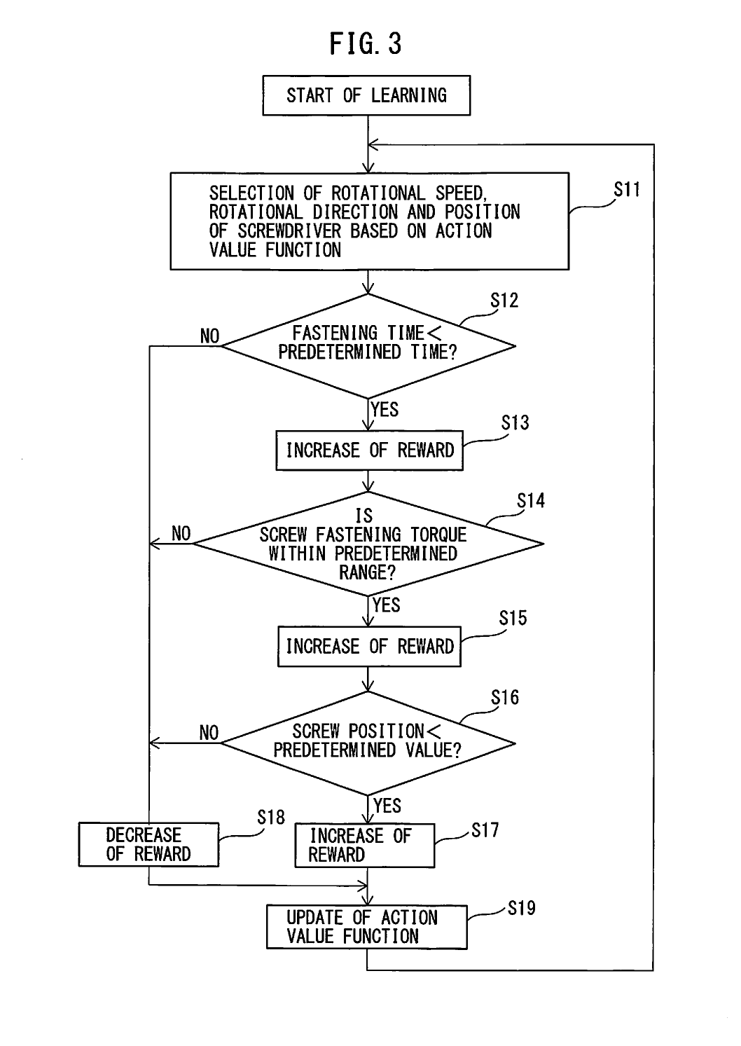

FIG. 3 shows a flow chart of the operations of the machine learning part 30. The operations of the machine learning part 30 will be discussed below with reference to FIGS. 1 to 3. The operations shown in FIG. 3 are carried out each time the screw fastening device 10 fastens the screw 45 into the planar plates 41 and 42.

First, at step S11 in FIG. 3, the rotational speed V, the rotational direction D, and the position P, of the screwdriver 11 are selected. The rotational speed V and the position P of the screwdriver 11 are randomly selected from the respective predetermined ranges. Regarding the rotational direction D of the screwdriver 11, one of the clockwise direction and the counterclockwise direction is randomly selected.

Alternatively, regarding the rotational speed V of the screwdriver 11, the minimum value in the predetermined range may be first selected and thereafter, a value with a slight value added may be selected in the next cycle. The same is true for the position P of the screwdriver 11. The operations shown in FIG. 3 may be repeated so that all combinations of the rotational speed V, the rotational direction D, and the position P are selected.

Then, at step S12, the fastening time taken to fasten one screw 45 is detected by the fastening time detection unit 25 and is compared with a predetermined time. If the fastening time is below the predetermined time, the reward is increased at step S13. Conversely, if the fastening time is not less than the predetermined time, the reward is decreased or remains unchanged at step S18.

Then, at step S14, whether the screw fastening torque detected by the torque sensor 24a is within a predetermined range is checked. If the screw fastening torque is within the predetermined range, the reward is increased at step S15. Conversely, if the screw fastening torque is out of the predetermined range, the reward is decreased or remains the same at step S18.

At step S16, whether the screw position detected by the distance sensor 24b is less than a predetermined value is checked. If the screw position is less than the predetermined value, the reward is increased at step S17. Conversely, if the screw position is not less than the predetermined value, the reward is decreased or remains the same at step S18.

The increase or decrease of the reward is calculated by the reward calculation unit 32. The amount of increase or decrease of the reward may be set to differ depending on the step. Also, it is possible to omit at least one of the judgment steps S12, S14 and S16 and the reward steps associated therewith.

Thereafter, at step S19, the function update unit 33 updates the action value function. The Q-learning performed by the learning unit 35 is the method for learning the value (action value) Q (s, a) of selecting the action “a” in a certain environment s. At the environment s, the highest action “a” of Q (s, a) is selected. In the Q-learning, the various actions “a” are taken under the environment s by trial and error, and a correct Q (s, a) is learned using the rewards at those times. The update expression of the action value function Q (s, a) is represented by the following formula (1).

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

wherein sₜ, aₜ represent the environment and action at time t, respectively. The environment sₜ is changed to sₜ₊₁ in accordance with the action aₜ, and the reward rₜ₊₁ is calculated in accordance with the change of the environment. The term with “max” in the formula is identical to the Q value multiplied by γ when the action “a” having the highest value of Q (known at that time) is selected in the environment sₜ₊₁. γ represents a discount rate which satisfies 0<γ≦1 (normally, 0.9 to 0.99) and α represents the learning rate which satisfies 0<α≦1 (normally, approximately 0.1).

The aforementioned formula indicates that if the evaluation value Q(sₜ, aₜ) of the action “a” in the state s is less than the evaluation value Q(sₜ₊₁, maxaₜ₊₁) of the most favorable action “a” in the next environment state, the Q(sₜ, aₜ) is increased, and if the opposite is true, Q(sₜ, aₜ) is decreased. Thus, the value of a certain action in a certain state is made to be close to the value of the most favorable action in the next state thereby. In other words, the learning unit 35 updates the conditions most suitable for the fastening operation of the screw 45, that is, the optimum rotational speed of the screw driver 11, the optimum rotational direction of the screwdriver 11, the optimum position of the screwdriver 11, and the optimum inclination of the screwdriver 11.

As mentioned above, the function update unit 33 updates the action value using the formula (1) at step S19. Thereafter, the control is returned to step S11 where another rotational speed V, position P and rotational direction D of the screwdriver 11 are selected, and the action value function is updated in the same manner as above. Note that, the action function table may be updated in place of the action value function.

In the reinforcement learning, the learning unit 35 as an agent determines the action based on the environmental state. The action referred to herein means that the decision making unit 34 selects the respective amounts of adjustment of the rotational speed regulation unit 21, the rotational direction regulation unit 22, and the position regulation unit 23 and operates them in accordance with the respective amounts of adjustment. Consequently, the environment indicated in FIG. 2 by the rotational speed, the rotational direction, and the position of the screwdriver 11 adjusted by the respective amounts of adjustment, e.g., the fastening quality and the fastening time are changed. In accordance with the change of the environment, the reward is given to the machine learning part 30 as mentioned above, so that the decision making unit 34 of the machine learning part 30 learns the selection (decision) of a more favorable action so as to acquire, for example, a higher reward.

Therefore, by repeating the operations illustrated in FIG. 3 many times, the reliability of the action value function is enhanced. In addition, by selecting the rotational speed V, the rotational direction D, and the position P of the screwdriver 11 based on the action value function having a high reliability so as to increase, for example, the Q value at step S11, the rotational speed V, etc., of the screwdriver 11 can be determined optimally.

Thus, the contents updated by the function update unit 33 of the machine learning part 30 of the present invention can be automatically determined as having a more appropriate rotational speed, rotational direction and position of the screwdriver 11 when fastening the screw 45. The introduction of the machine learning part 30 into the control device 20 of the screw fastening system makes it possible to automatically adjust the optimum rotational speed of the screwdriver 11 in the case of possible occurrence of screw jamming. Thus, it is possible to carry out an automated assembly without stopping the assembly line including the screw fastening device 10. As a result, the productivity can be enhanced. Moreover, the screw fastening time can be shortened by performing the fastening operation at the optimum rotational speed, etc.

### EFFECTS OF THE INVENTION

According to the first and second aspects of the invention, a machine learning device which is capable of automatically determining the optimum rotational speed, etc., of the screwdriver can be provided.

According to the third to sixth aspects of the invention, the reward can be determined more appropriately.

According to the seventh and eighth aspects of the invention, as the machine learning is introduced into the screw fastening system or the control device thereof, the optimum rotational speed, etc., of the screwdriver can be automatically determined. As a result, it is possible to carry out an automated assembly without stopping the assembly line. Consequently, the productivity can be increased. Moreover, it is possible to shorten the screw fastening time by performing the fastening operation at the optimum rotational speed, etc.

Although the above discussion has been applied to representative embodiments, the present invention can be subjected to the aforementioned modifications, various other modifications, omission, or addition without departing from the spirit of the invention.

What is claimed is:

1. A machine learning device for learning the fastening operation of a screw by a screwdriver, comprising
a state observation unit for observing state variables including at least one of a rotational speed of the screwdriver, a rotational direction of the screwdriver, a position of the screwdriver and an inclination of the screwdriver, and at least one of a fastening quality of the screw fastened by the screwdriver and a fastening time for which the screw is fastened by the screwdriver, and
a learning unit for learning at least one of the rotational speed, the rotational direction, the position and the inclination, observed by the state observation unit and at least one of a change of the fastening quality and a change of the fastening time, observed by the state observation unit in association with each other.

2. A machine learning device according to claim 1, wherein the learning unit comprises a reward calculation unit which calculates a reward based on at least one of the fastening quality and the fastening time, observed by the state observation unit, and a function update unit which updates a function to determine at least one of an optimum rotational speed of the screwdriver, an optimum rotational direction of the screwdriver, an optimum position of the screwdriver and an optimum inclination of the screwdriver, from the current state variables based on the reward calculated by the reward calculation unit.

3. A machine learning device according to claim 2, wherein the reward calculation unit is configured to decrease the reward when the fastening time is greater than a predetermined time.

4. A machine learning device according to claim 2, wherein the reward calculation unit is configured to increase the reward when the fastening time is not greater than a predetermined time.

5. A machine learning device according to claim 2, wherein the fastening quality includes at least one of a screw fastening torque and a position of a screw which has been fastened, and the reward calculation unit is configured to reduce the reward in at least one of the cases where the screw fastening torque is out of a predetermined range and where the screw position is greater than a predetermined value.

6. A machine learning device according to claim 2, wherein the fastening quality includes at least one of a screw fastening torque and a position of a screw which has been fastened, and the reward calculation unit is configured to increase the reward in at least one of the cases where the screw fastening torque is within a predetermined range and where the screw position is not greater than a predetermined value.

7. A control device for a screw fastening system in which a screw is fastened by a screwdriver, comprising
a rotational speed regulation unit which regulates the rotational speed of the screwdriver,
a rotational direction regulation unit which regulates the rotational direction of the screwdriver,
a position regulation unit which regulates the position and inclination of the screwdriver,
a fastening quality detection unit which detects the fastening quality of the screw fastened by the screwdriver,
a fastening time detection unit which detects the fastening time required to fasten the screw by the screwdriver,
a machine learning device according to claim 1,
and a decision making unit which determines and outputs an amount of adjustment of at least one of the rotational speed regulation unit, the rotational direction regulation unit, the position regulation unit, from the current state variables based on the learning result of the learning unit so as to determine at least one of the optimum rotational speed of the screwdriver, the optimum rotational direction of the screwdriver, the optimum position of the screwdriver, and the optimum inclination of the screwdriver.

8. A screw fastening system comprising a control device according to claim 7 and a screw fastening device having the screwdriver.
